(19) United States
(12) Patent Application Publication
(10) Pub. No.: US 2009/0109878 A1
(43) Pub. Date: Apr. 30, 2009

(54) METHOD FOR INFORMING THAT THE NETWORK SUPPORTS THE MOBILE IP ENHANCEMENT CAPABILITY

(76) Inventors: Jixing LIU, Shenzhen (CN); Jie ZHAO, Shenzhen (CN); Jie WANG, Shenzhen (CN); Xia YANG, Shenzhen (CN)

Correspondence Address: BRINKS HOFER GILSON & LIONE, P.O. BOX 10395, CHICAGO, IL, 60610, US

(21) Appl. No.: 12/345,001

(22) Filed: Dec. 29, 2008

Related U.S. Application Data
(63) Continuation of application No. PCT/CN2007/002560, filed on Aug. 24, 2007.

(30) Foreign Application Priority Data
Nov. 22, 2006 (CN) 200610114764.9

(51) Int. Cl. H04L 12/16

(52) U.S. Cl. 370/259

(57) ABSTRACT

A method for informing that the network supports the mobile Internet Protocol (IP) enhancement capability includes the network sending a message indicating the mobile IP enhancement capability of the network to a mobile station (MS). If the MS supports the mobile IP enhancement capability, the MS requests the enhanced mobile IP service according to the mobile IP enhancement specifications. If the MS does not support the mobile IP enhancement capability, the MS requests the mobile IP service according to the specifications which do not support mobile IP enhancement. The packet data access gateway may be a packet data serving node (PDSN) or a controlling access point (CAP) in a Code Division Multiple Access (CDMA) evolving network. Therefore, the method provided by the present disclosure enables the MS to learn the mobile IP enhancement capability of the network without having to resending requests, thus avoiding the waste of air interface resources.

### CROSS REFERENCES TO RELATED APPLICATIONS

This application is a continuation application of PCT/CN2007/002560, filed Aug. 24, 2007 which claims priority to the Chinese Patent Application No. 200610114764.9, filed with the Chinese Patent Office on Nov. 22, 2006 and entitled “Method for Informing that the Network Supports the Mobile IP Enhancement Capability”, the contents of both of which are incorporated herein by reference in their entirety.

### FIELD OF THE DISCLOSURE

The present disclosure relates to mobile IP enhancement, and in particular, to a method for informing a mobile station (MS) that the network supports the mobile IP enhancement capability.

### BACKGROUND OF THE DISCLOSURE

The 3rd Generation Partnership Project 2 (3GPP2) has formulated related specifications of the Code Division Multiple Access 2000 (CDMA2000) 1x packet data network and adopted the mobile IP technologies of the Internet Engineering Task Force (IETF), thereby enabling the network to implement fast IP access, interwork with other IP networks, and provide better roaming support and IP service capabilities of private networks.

The access gateway that connects the wireless network and packet data network is a packet data serving node (PDSN) and provides packet data access services for the MS. The PDSN, similar to an access server, provides the next-hop routes for packets. When mobile IPv4 is deployed in the network, the PDSN also works as a foreign agent (FA).

The existing CDMA2000 systems include 3G 1x and high rate packet data (HRPD, which evolves from CDMA2000 1x, optimizes packet data services, and was recognized as a 3G technical specification by the ITU in 2001) systems. The Point-to-Point Protocol (PPP, a data link layer protocol that implements transfer of the encapsulated network layer packets over point-to-point links) is used between the MS (including the MS used in CDMA2000 1x and HRPD systems) and the PDSN.

3GPP2 X.S0011-D (CDMA2000 Wireless IP Network Standard) describes how to allocate a home agent (HA) dynamically to an MS in the home network over mobile IPv4 and mobile IPv6. The 3GPP2 is developing new specifications for enhancing the mobile IP capability specified in X. S0011-D aiming to better support the real-time services for a roaming MS and to realize that the data between the MS and the peer node does not need to be sent through the home network of the MS. The specifications under development include X.P0044 (mobile IPv4 enhancement) and X.P0047 (mobile IPv6 enhancement).

Compared with the specifications in 3GPP2 X.S0011-D, mobile IP enhancement provides the capability of allocating an HA in visited locations and specifies the corresponding mechanism.

In mobile IPv4 enhancement, when sending an RRQ message (MIP Registration Request), the MS sets the HA address in the RRQ message. If the HA address is set to 0.0.0.0, an HA can be allocated in the home network or the visited network. If the HA address is set to 255.255.255.255, an HA is allocated in the home network. In 3GPP2 X. S0011-D, the RRQ message always contains the MN-HA Authentication Extension. In mobile IPv4 enhancement, the RRQ message contains the MN-HA Authentication Extension only during re-registration.

FIG. 1 shows a signaling flowchart for allocating an HA dynamically in the visited network. In mobile IPv4 enhancement, the Remote Authentication Dial-in User Service (RADIUS) protocol is used for dynamic HA allocation in the visited location. The flow is as follows:

Step 101: A PPP session is established between the MS and the PDSN.

Step 102: The PDSN sends an agent advertisement carrying the MN-FA Challenge Extension to the MS.

Step 103: The MS sends a mobile IP RRQ message to the PDSN. The message carries the MN-NAI Extension, MN-FA Challenge Extension, and MN-AAA Authentication Extension. AAA stands for authentication, authorization and accounting. In the RRQ message, if the HoA (home address) field is set to 0.0.0.0, the dynamic HoA allocation can be requested. If the HA field is set to 0.0.0.0, an HA can be allocated in the visited location.

Step 104: The PDSN sends a RADIUS Access-Request message to the home AAA server (H-AAA) to authenticate the MN-AAA Extension. The RADIUS Access-Request message contains the Local-HA-Assignment-Capability VSA (Vendor Specific Attribute) indicating the request for dynamic HA allocation in the visited location.

Step 105: If the authentication succeeds, the H-AAA returns a RADIUS Access-Accept message that contains the Local-HA-Assignment-Authorized VSA authorizing the visited network to allocate an HA to the MS.

Step 106: The PDSN allocates an HA of the visited network based on the visited network policy.

Step 107: The PDSN forwards the RRQ message to the allocated HA.

Step 108: The HA allocates an HoA to the MS.

Step 109: The HA in the visited network sends a RADIUS Access-Request message to the H-AAA to authenticate the MN-AAA and request the MN-HA key. The message contains the MN-HA SPI (Security Parameter Index) VSA, HoA and MIP4-Mesg-ID VSA required for generating a key.

Step 110: The H-AAA authenticates the user and calculates the MN-HA key.

Step 111: The H-AAA sends a RADIUS Access-Accept message carrying the MN-HA-Shared-Key VSA.

Step 112: The HA generates an RRP message (MIP Registration Reply) carrying the MN-HA Authentication Extension calculated through the MN-HA-Shared Key and sends the RRP message to the PDSN for forwarding to the MS.

Step 113: The MS generates the MN-HA key and verifies the MN-HA Authentication Extension in the RRP message.

In 3GPP2 X.S0011-D, when the MS supports mobile IPv6, the home network information is carried through the 3GPP2 Vendor Option in the DHCP message based on the Dynamic Host Configuration Protocol (DHCP) to obtain the bootstrap information. In mobile IPv6 enhancement, the home network information is carried through the Home Network Information Option defined in an IETF draft. The MS uses the Home Network Identifier Option to indicate whether an HA is allocated in the visited network or in the home network. The value 0 indicates that an HA is allocated in the visited network, and 1 indicates that the HA is allocated in the home network.

FIG. 2 shows the signaling flow for allocating an HA dynamically in the visited network. In mobile IPv6 enhancement, an HA is dynamically allocated in the visited location based on the RADIUS protocol. The procedure is as follows:

Step 201: The MS originates the access authentication process.

Step 202: The PDSN sends a RADIUS Access-Request message to the home RADIUS server. The PDSN supports local HA allocation and carries the MIP6-HA-Local-Assignment-Capability VSA in the RADIUS message to indicate the local HA allocation capability.

Step 203: The home RADIUS server authenticates the MS, allocates an HA in the home network to the MS, and authorizes the visited network to allocate an HA.

Step 204: The home RADIUS server carries the address of the HA allocated in the home network through the MIP6 Home Agent VSA in the RADIUS Access-Accept message. It also carries the HA-Authorized VSA in the message to indicate that the visited network is authorized to allocate an HA in the visited location as requested by the MS.

Step 205: The PDSN stores the address of the HA allocated in the home network so that the HA in the home network can be allocated to the MS upon request.

Step 206: The authentication is complete.

Step 207: The MS requests the mobile IPv6 bootstrap information by sending a DHCPv6 Information-request message to the PDSN. The message contains the network access identifier (NAI). Because the MS requests to allocate an HA in the visited network, the MS carries the Home Network Identifier Option in the DHCP message and sets the id-type to 0.

Step 208: The PDSN allocates an HA in the visited network to the MS.

Step 209: The PDSN returns a Reply message carrying the HA list in the Home Network Information Option.

The prior art cannot solve the compatibility problems, that is, an MS that supports mobile IP enhancement cannot access a network that does not support mobile IP enhancement, or an MS that does not support mobile IP enhancement cannot access a network that supports mobile IP enhancement. Details are provided below based on mobile IPv4 enhancement and mobile IPv6 enhancement:

1. The MS supports mobile IPv4 enhancement, but the network only supports mobile IPv4.

Because the MS supports mobile IPv4 enhancement, the MS sends an RRQ request without the MN-HA AE for registration. Because the PDSN does not support mobile IPv4 enhancement, the PDSN rejects the registration request and returns an RRP message with the code of 70 indicating a poorly formed request. In this case, the MS needs to roll back and originate the registration according to 3GPP2 X.S0011-D specifications. If the RRP message has multiple format errors, the MS cannot identify the errors, may fail to roll back correctly, and thus cannot obtain mobile IPv4 services. In addition, even though the MS moves to a network that supports mobile IPv4 enhancement, the MS cannot request an HA in the visited location because of the inability of learning whether the network supports the mobile IPv4 enhancement capability.

2. The MS only supports mobile IPv4, and the network supports mobile IPv4 enhancement.

According to 3GPP2 X.S0011-D, the MS sends an RRQ message that contains the MN-HA Authentication Extension for registration. The PDSN needs to identify whether the registration is the initial registration of an MS that does not support mobile IP enhancement or the re-registration of an MS that supports mobile IP enhancement. The PDSN can determine that the MS complies with 3GPP2 X.S0011-D but does not support mobile IPv4 enhancement only when the RRQ message is for initial registration and contains the MN-HA Authentication Extension.

3. The MS supports mobile IPv6 enhancement, but the network only supports mobile IPv6.

The MS carries the Home Network Identifier Option in the DHCPv6 Information-request message to request the HA bootstrap information. The PDSN does not return the requested information because the PDSN does not support mobile IPv6 enhancement. In this case, the MS rolls back and requests an HA in the home network through the vendor specific option according to 3GPP2 X.S0011-D. In addition, even though the MS moves to a network that supports mobile IPv6 enhancement, the MS cannot request an HA in the visited location because of the inability of learning whether the network supports the mobile IPv6 enhancement capability.

4. The MS only supports mobile IPv6, and the network supports mobile IPv6 enhancement.

The MS requests the bootstrap information according to the 3GPP2 X.S0011-D specifications. Because the MS does not support mobile IPv6 enhancement, the PDSN does not carry the Home Network Identifier Option in the message but returns the bootstrap information through the vendor specific option.

According to the foregoing analyses, because there is no effective method for an MS to know whether the network supports mobile IP enhancement, problems may occur when an MS that supports mobile IP enhancement accesses a network that does not support mobile IP enhancement, or an MS that does not support mobile IP enhancement accesses a network that supports mobile IP enhancement. For example, an MS that supports mobile IP enhancement may fail to roll back properly when it accesses a network that does not support mobile IP enhancement.

Further, the MS may know the mobile IP enhancement capability of the network only after receiving a response message and needs to resend a request message, thus wasting air interface resources.

In addition, when an MS moves to a network that supports the mobile IP enhancement capability, without an effective notification mechanism, the MS cannot request enhanced mobile IP services and new services cannot be deployed through the network.

### SUMMARY OF THE DISCLOSURE

The present disclosure provides a method for informing an MS whether the network supports the mobile IP enhancement capability to overcome the defects of the prior art. In this way, when accessing network services, an MS that supports mobile IP enhancement can obtain the mobile IP enhancement capability of the network, request enhanced mobile IP services, and originate mobile IP service requests correctly according to the network capability so that the messages can be reduced and resources can be saved.

To realize the above objective, an embodiment of the present disclosure provides a method for informing that the network supports the mobile IP enhancement capability. The method includes sending, by the network, a message indicating the mobile IP enhancement capability supported by the network to an MS, and by the MS when the network supports the mobile IP enhancement capability, requesting the enhanced mobile IP service according to the indication of the mobile IP enhancement capability supported by the network and the mobile IP enhancement specifications where when the MS does not support the mobile IP enhancement capability, ignoring the indication and requesting the mobile IP service according to the specifications which do not support mobile IP enhancement.

The message indicating the mobile IP enhancement capability supported by the network is sent by a packet data access gateway in the network.

When the access gateway is a PDSN in a CDMA network, the method includes sending, by the PDSN, a message indicating the version support capability to the MS based on the PPP Vendor Extension, by the MS, returning a response to the PDSN based on the PPP Vendor Extension to indicate that the indication message is received, and by the MS, checking the version capability indication message; if the MS supports the mobile IP enhancement capability, checking whether the network supports mobile IP enhancement, and when the network does support mobile IP enhancement, requesting the enhanced mobile IP service according to mobile IP enhancement specifications, and when the network does not support mobile IP enhancement, requesting the mobile IP service according to the specifications which do not support mobile IP enhancement and when the MS does not support the mobile IP enhancement capability, ignoring the mobile IP enhancement capability indication, and requesting the mobile IP service according to the specifications which do not support mobile IP enhancement.

The version capability indication message contains the indication of the mobile IP enhancement capability. The MS checks the version capability indication by checking or ignoring the indication of the mobile IP enhancement capability. The specific steps are as follows: When the MS supports the mobile IP enhancement capability, if the bit indicating the mobile IP enhancement capability is 1, the MS determines that the network supports mobile IP enhancement. If the bit indicating the mobile IP enhancement capability is 0, the MS determines that the network does not support mobile IP enhancement. If the MS does not support the mobile IP enhancement capability, it ignores the mobile IP enhancement capability indication.

The version capability indication message contains the List of Capability field. The MS checks the version capability indication message by checking the bit that indicates the mobile IP enhancement in the List of Capability field. The specific steps are as follows: When the MS supports the mobile IP enhancement capability, if the bit indicating the mobile IP enhancement capability is 1, the MS determines that the network supports mobile IP enhancement. If the bit indicating the mobile IP enhancement capability is 0, the MS determines that the network does not support mobile IP enhancement. If the MS does not support the mobile IP enhancement capability, the MS ignores the bit that indicates the mobile IP enhancement capability.

The version capability indication message contains the Version field. The MS checks the version capability indication message by checking the Version field. The specific steps are as follows: When the MS supports the mobile IP enhancement capability, if the Version field is 1, the MS determines that the network supports mobile IP enhancement. If the Version field is 0, the MS determines that the network does not support mobile IP enhancement. If the MS does not support the mobile IP enhancement capability, the MS only checks whether the Version field is not smaller than 0.

When the packet data access gateway is a PDSN, the method includes sending, by the PDSN, a message indicating the mobile IP enhancement capability to the MS based on the PPP Vendor Extension and by the MS, receiving the message indicating the mobile IP enhancement capability, and when the MS supports the IP enhancement capability, returning a response to the PDSN based on the PPP Vendor Extension to indicate that the indication message is received or when the MS does not support the mobile IP enhancement capability, which means it is unable to identify the indication message, returning a rejection message.

If the MS supports the IP enhancement capability, the MS requests the enhanced mobile IP service according to the mobile IP enhancement specifications. If the MS does not support the mobile IP enhancement capability, the MS requests the mobile IP service according to the specifications which do not support mobile IP enhancement.

When the packet data access gateway is a controlling access point (CAP) in a CDMA evolving network, the method includes sending, by the CAP, a message indicating the mobile IP enhancement capability to the MS through the air interface and by the MS, receiving the message indicating the mobile IP enhancement capability, and when the MS supports the IP enhancement capability, returning a response to the CAP through the air interface to indicate that the indication message is received or when the MS does not support the mobile IP enhancement capability, being unable to identify the indication message, and thus returning a rejection message.

If the MS supports the IP enhancement capability, the MS requests the enhanced mobile IP service according to the mobile IP enhancement specifications. If the MS does not support the mobile IP enhancement capability, the MS requests the mobile IP service according to the specifications which do not support mobile IP enhancement.

Therefore, the method provided in embodiments of the present disclosure enables the MS to know whether the network supports the mobile IP enhancement capability, thus avoiding problems. For example, an MS that supports mobile IP enhancement may fail to roll back properly when the MS accesses a network that does not support mobile IP enhancement. In addition, the MS does not need to resend requests and thus avoids the waste of air interface resources.

The present disclosure is hereinafter described in detail with reference to embodiments and accompanying drawings.

### BRIEF DESCRIPTION OF THE DRAWINGS

FIG. 1 shows the signaling flow for allocating an HA dynamically in the visited network according to the prior art;

FIG. 2 shows the signaling flow for allocating an HA dynamically in the visited network according to the prior art;

FIG. 3 shows the format of the version capability indication message according to the method for informing that the network supports the mobile IP enhancement capability provided in an embodiment of the present disclosure;

FIG. 4 is a flowchart of the method for informing that the network supports the mobile IP enhancement capability according to embodiment 1 of the present disclosure;

FIG. 5 is another flowchart of the method for informing that the network supports the mobile IP enhancement capability according to embodiment 1 of the present disclosure;

FIG. 6 shows the mobile IP enhancement capability defined in the method for informing that the network supports the mobile IP enhancement capability provided in an embodiment of the present disclosure;

FIG. 7 is a flowchart of the method for informing that the network supports the mobile IP enhancement capability according to embodiment 2 of the present disclosure;

FIG. 8 shows the basic architecture of an evolving network for the method for informing that the network supports the mobile IP enhancement capability according to an embodiment of the present disclosure; and

FIG. 9 is a flowchart of the method for informing that the network supports the mobile IP enhancement capability according to embodiment 3 of the present disclosure.

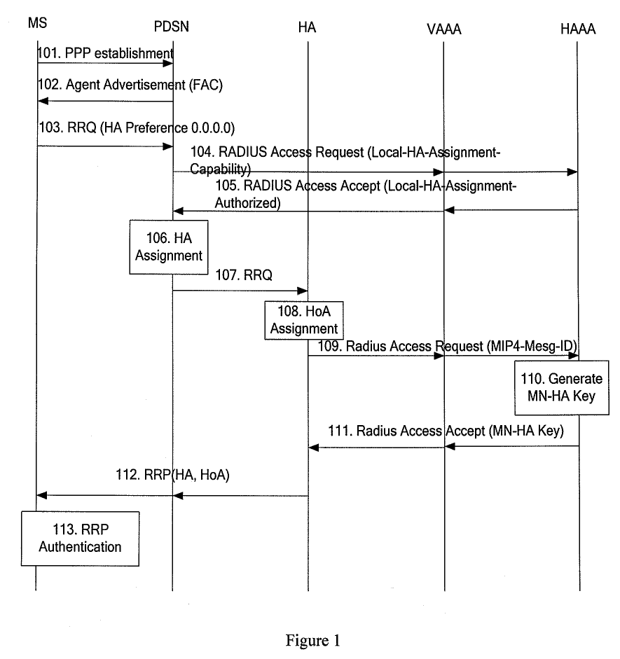

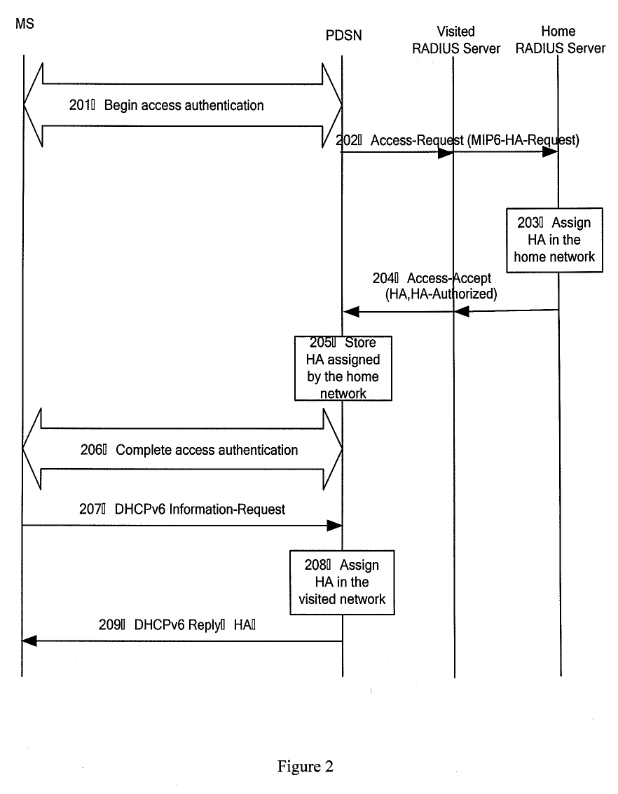

### DETAILED DESCRIPTION OF THE DISCLOSURE

According to embodiments of the present disclosure, the network informs an MS whether the network supports the mobile IP enhancement capability so that the MS can decide whether to request mobile IP services according to the mobile IP enhancement specifications based on the mobile IP enhancement capability of the network. The informing can be performed when a data session is established between the MS and the access gateway.

If the network supports mobile IP enhancement, the network informs the MS. If the MS also supports mobile IP enhancement, the MS requests the mobile IP service according to mobile IP enhancement specifications. If the MS does not support mobile IP enhancement, the MS is unable to identify the capability indication and requests the mobile IP service according to the 3GPP2 X.S0011-D specifications.

If the network does not support mobile IP enhancement, the network does not inform the MS of the mobile IP enhancement capability. If the MS does not support mobile IP enhancement, the MS requests the mobile IP service according to the 3GPP2 X.S0011-D specifications. If the MS supports mobile IP enhancement capability, the MS also requests the mobile IP services according to the 3GPP2 X.S0011-D specifications because the MS is not informed. When the MS that supports the mobile IP enhancement capability moves to a network that supports the mobile IP enhancement capability, the MS will be informed and thus can request the enhanced mobile IP service.

A method for informing that the network supports the mobile IP enhancement capability includes the following steps:

The packet data access gateway sends a message indicating the mobile IP enhancement capability supported by the network to the MS.

If the MS supports the mobile IP enhancement capability, the MS requests the mobile IP service according to the indication and the mobile IP enhancement specifications. If the MS does not support the mobile IP enhancement capability, the MS ignores the indication and requests the mobile IP service according to the specifications which do not support mobile IP enhancement.

### EMBODIMENT 1

The mobile IP enhancement capability of the network is indicated in the version capability indication message of the PDSN.

According to 3GPP2 X.S0011-D, the versions and capabilities supported by the MS and PDSN are negotiated based on the PPP Vendor Extension.

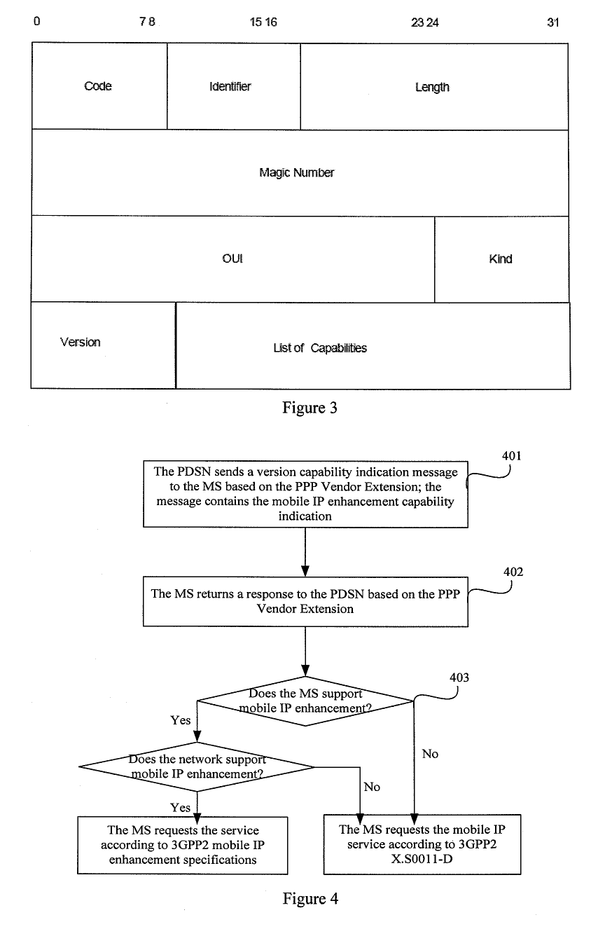

FIG. 3 shows the format of a version capability indication message according to the present disclosure.

Code: 0 indicates the vendor extension;

Identifier: used to match the packets sent and received;

Length: 16;

Magic Number: used to detect links;

OUI: Organizationally Unique Identifier. 0xCF0002 stands for 3GPP2;

Kind: 2 stands for the version capability indication; 3 indicates the version capability reply;

Version: 0 indicates that the mandatory capabilities specified in the 3GPP2 X.S0011-D are supported; other values are reserved;

List of Capability: indicates the capability supported.

The List of Capability of the PDSN consists of 24 bits, each of which stands for a supported capability. Table 1 lists the capabilities supported by the PDSN.

TABLE 1

| Bit | Capability |
|---|---|
| C0 | Supporting the auxiliary connection of service option 60 |
| C1 | Supporting the auxiliary connection of service option 61 |
| C2 | Supporting the auxiliary connection of service option 66 |
| C3 | Supporting mobile IPv4 deregistration |
| C4 | Supporting the auxiliary connection of service option 64 |
| C5 | Supporting the auxiliary connection of service option 67 |
| C6-C23 | Reserved |

The sender must set the reserved bits to 0, and the receiver should ignore the reserved bits.

A method for informing that the network supports the mobile IP enhancement capability includes:

Step 1: The PDSN sends a message indicating the version support capability to the MS based on the PPP Vendor Extension.

Step 2: The MS ret urns a response to the PDSN based on the PPP Vendor Extension, indicating that the indication message is received.

Step 3: The MS checks the version capability indication message. If the MS supports the mobile IP enhancement capability, the MS checks whether the network supports mobile IP enhancement. If the network supports mobile IP enhancement, the MS requests the enhanced mobile IP service according to mobile IP enhancement specifications. Otherwise, the MS requests the mobile IP service according to the specifications which do not support mobile IP enhancement. If the MS does not support the mobile IP enhancement capability, the MS requests the mobile IP service according to the specifications which do not support mobile IP enhancement.

The following modes can be used to indicate that the network supports the mobile IP enhancement capability:

(1) Using the Reserved Bits in the List of Capability

Suppose that bit 6 indicates that mobile IPv4 enhancement is supported and bit 7 indicates that mobile IPv6 enhancement is supported. Table 2 lists the capabilities of the PDSN.

TABLE 2

| Bit | Capability |
|---|---|
| C0 | Supporting the auxiliary connection of service option 60 |
| C1 | Supporting the auxiliary connection of service option 61 |
| C2 | Supporting the auxiliary connection of service option 66 |
| C3 | Supporting mobile IPv4 deregistration |
| C4 | Supporting the auxiliary connection of service option 64 |
| C5 | Supporting the auxiliary connection of service option 67 |
| C6 | Supporting mobile IPv4 enhancement |
| C7 | Supporting mobile IPv6 enhancement |
| C8-C23 | Reserved |

If mobile IP enhancement is supported, both mobile IPv4 enhancement and mobile IPv6 enhancement must be supported. In this case, only one bit is used to indicate the mobile IP enhancement capability.

FIG. 4 is a flowchart of the method for informing that the network supports the mobile IP enhancement capability according to embodiment 1 of the present disclosure. The steps are as follows:

Step 401: The PDSN sends a version capability indication message to the MS based on the PPP Vendor Extension. The version capability message contains the mobile IP enhancement capability indication.

Step 402: The MS returns a response to the PDSN based on the PPP Vendor Extension indicating that the indication message is received.

Step 403: The MS checks the version capability indication message by checking or ignoring the mobile IP enhancement capability indication. If the MS supports the mobile IP enhancement capability, the MS checks whether the network supports mobile IP enhancement. If the bit indicating the mobile IP enhancement capability is 1, the network supports mobile IP enhancement, and the MS requests the enhanced mobile IP service according to the mobile IP enhancement specifications (such as 3GPP2 mobile IPv6 enhancement specifications). If the bit indicating the mobile IP enhancement capability is 0, the network does not support mobile IP enhancement, and the MS requests the mobile IP service according to the specifications which do not support mobile IP enhancement (such as 3GPP2 X.S0011-D).

(2) Using the Version Field to Indicate Mobile IP Enhancement

If Version is set to 0, the mandatory capabilities specified in 3GPP2 X.S0011-D are supported. The value 1 can be used to indicate the supported mobile IP enhancement capability.

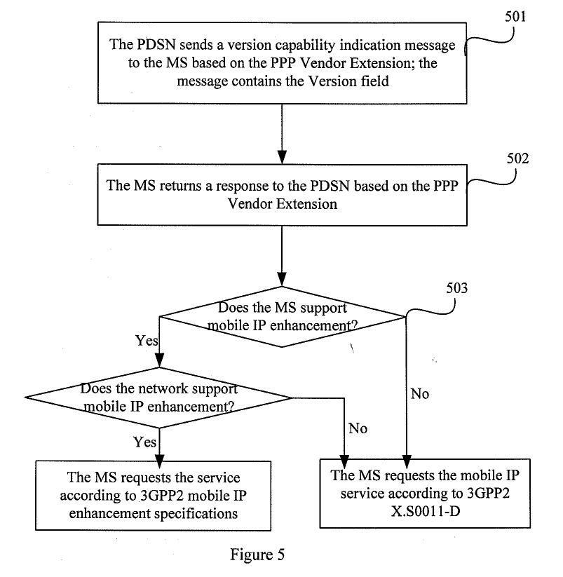

FIG. 5 is another flowchart of the method for informing that the network supports the mobile IP enhancement capability according to embodiment 1 of the present disclosure. The steps are as follows:

Step 501: The PDSN sends a version capability indication message to the MS based on the PPP Vendor Extension. The version capability indication message contains the Version field.

Step 502: The MS returns a response to the PDSN based on the PPP Vendor Extension indicating that the Version field is received.

Step 503: The MS checks the version capability indication message by checking or ignoring the Version field. If the MS supports the mobile IP enhancement capability, the MS checks whether the network supports mobile IP enhancement. If the Version field is 1, the network supports mobile IP enhancement, and the MS requests the enhanced mobile IP service according to the mobile IP enhancement specifications (such as 3GPP2 mobile IPv6 enhancement specifications). If the Version field is 0, the network does not support mobile IP enhancement, and the MS requests the mobile IP service according to the specifications which do not support mobile IP enhancement (such as 3GPP2 X.S0011-D).

### EMBODIMENT 2

### Using Another Vendor Extension for Informing That the Network Supports the Mobile IP Enhancement Capability

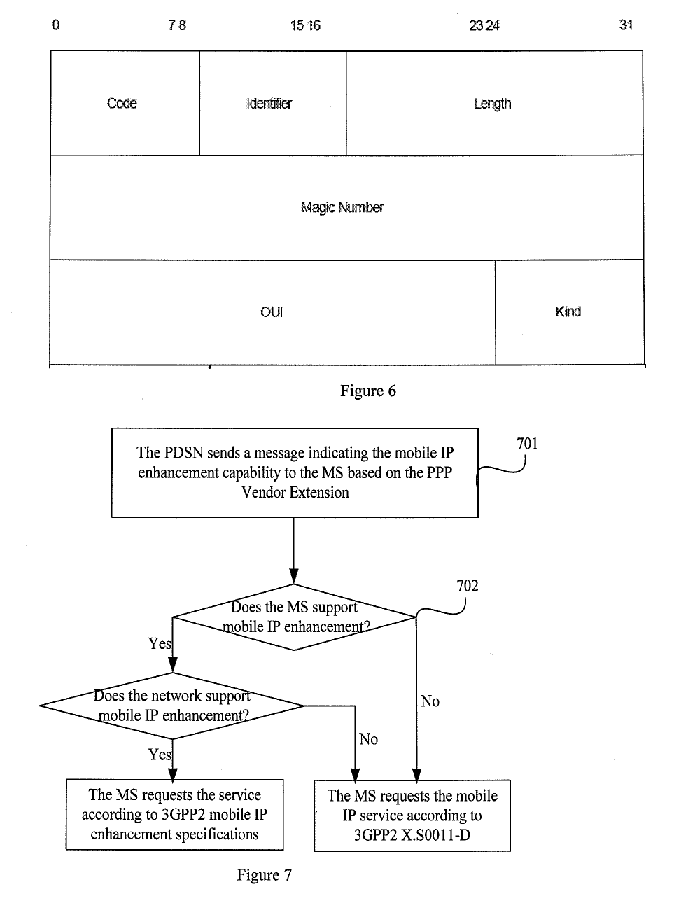

FIG. 6 shows the mobile IP enhancement capability defined.

Code: 0 indicates the vendor extension;

Identifier: used to match the packets sent and received;

Length: 16;

Magic Number: used to detect links;

OUI: Organizationally Unique Identifier. 0xCF0002 stands for 3GPP2;

Kind: 4 stands for the mobile IP enhancement capability indication; 5 indicates the mobile IP enhancement capability reply.

FIG. 7 is a flowchart of the method for informing that the network supports the mobile IP enhancement capability according to embodiment 2 of the present disclosure. The steps are as follows:

Step 701: The PDSN sends a message indicating the mobile IP enhancement capability to the MS based on the PPP Vendor Extension.

Step 702: The MS receives the message indicating the mobile IP enhancement capability. If the MS supports the IP enhancement capability, the MS returns a response to the PDSN based on the PPP Vendor Extension and requests the enhanced mobile IP service according to mobile IP enhancement specifications. If the MS does not support the mobile IP enhancement capability, the MS cannot identify the indication message (Kind=4), and thus returns a rejection message and requests the mobile IP service according to the specifications which do not support mobile IP enhancement (such as 3GPP2 X.S0011-D).

### EMBODIMENT 3

### Informing That the Network Supports the Mobile IP Enhancement Capability in a CDMA Evolving Network

To ensure the competitiveness of future systems, the 3GPP2 is engaged in the network evolution study, focusing on the long-term evolution of IP packet networks. The 3GPP2 aims to enhance the packet switching capability, simplify the network structure, improve the QoS, reduce the delay, raise the user data rate, system capacity and coverage, and reduce the operation costs so that the packet network can carry real-time and non-real-time services more effectively and provide various services for users.

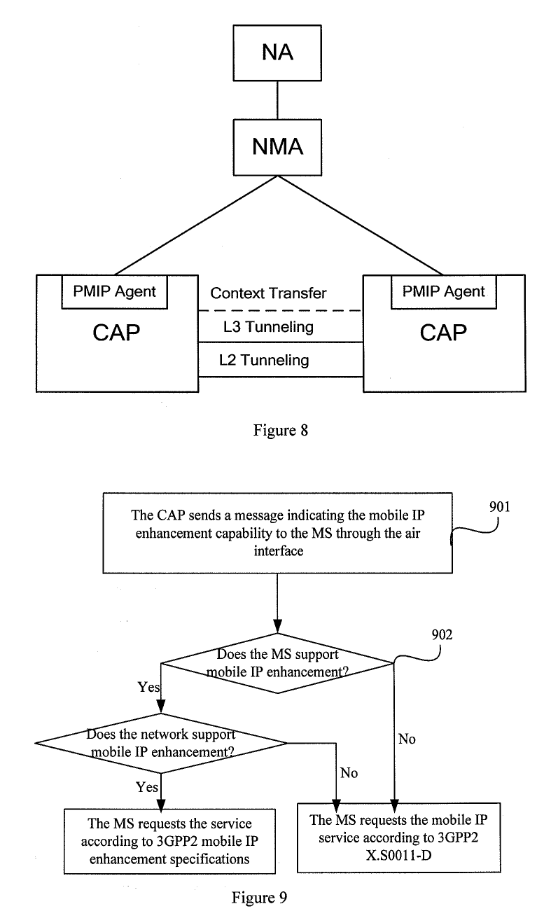

FIG. 8 shows the basic architecture of an evolving network based on network evolution requirements.

The CAP implements the access gateway function and wireless resource management. The access gateway serves as the first-hop router of the MS and implements mobility management, QoS support, and some functions of the original PDSN. The wireless resource management covers public resource management, specialized resource management, wireless session management, MS session status maintenance, and wireless link management. The network mobility agent (NMA) provides the L3 mobility management mechanism between CAPs. The dashed line indicates a signal flow and the real line indicates a user data flow.

In the evolving network, there are no PPP data links between the MS and the access gateway (namely, the CAP), and the signaling messages are sent between them through air interfaces.

Table 3 describes the network capability. The network capability can be indicated by a 24-bit value. The value 1 indicates that the network supports the capability, and 0 indicates that the network does not support the capability.

TABLE 3

| Bit | Capability |
|---|---|
| C0 | Supporting mobile IPv4 |
| C1 | Supporting mobile IPv6 |
| C2 | Supporting mobile IPv4 enhancement |
| C3 | Supporting mobile IPv6 enhancement |
| C4-C23 | Reserved |

If mobile IP enhancement is supported, both mobile IPv4 enhancement and mobile IPv6 enhancement must be supported. In this case, only one bit is used to indicate the mobile IP enhancement capability.

FIG. 9 is a flowchart of the method for informing that the network supports the mobile IP enhancement capability according to embodiment 3 of the present disclosure. The steps are as follows:

Step 901: The CAP sends a message indicating the mobile IP enhancement capability to the MS through the air interface.

Step 902: The MS receives the message indicating the mobile IP enhancement capability. If the MS supports the IP enhancement capability, the MS returns a response to the CAP through the air interface and requests the enhanced mobile IP service according to mobile IP enhancement specifications. If the MS does not support the mobile IP enhancement capability, the MS cannot identify the indication message, and thus returns a rejection message and requests the mobile IP service according to the specifications which do not support mobile IP enhancement.

If the access gateway functions and wireless functions of the CAP are implemented by different entities, the access gateway informs the related wireless function entity that the network supports the mobile IP enhancement capability, and then the wireless function entity informs the MS through the air interface.

For example, when the MS originates the access authentication process, the access gateway informs the related wireless function entity whether the network supports the mobile IP enhancement capability through the authentication response.

The related function entity informs the MS that the network supports the mobile IP enhancement capability through the air interface during the session negation with the AT.

The MS receives the message indicating the mobile IP enhancement capability. If the MS supports the IP enhancement capability, the MS returns a response to the related function entity through the air interface and requests the enhanced mobile IP service according to mobile IP enhancement specifications. If the MS does not support the mobile IP enhancement capability, the MS cannot identify the indication message, and thus returns a rejection message or ignores the message and requests the mobile IP service according to the specifications which do not support mobile IP enhancement.

The present disclosure provides a method and an effective mechanism for informing the MS that the network supports the mobile IP enhancement capability. In this way, a new MS that supports mobile IP enhancement can obtain the mobile IP enhancement capability of the network and request the enhanced mobile IP services when accessing network services. The MS can originate mobile IP service requests correctly according to the network capability, thus reducing the messages and saving the resources.

Although the disclosure has been described through some exemplary embodiments, the disclosure is not limited to such embodiments. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

What is claimed is:

1. A method for informing that a network supports a mobile Internet Protocol (IP) enhancement capability, comprising:
sending, by the network, a message indicating the mobile IP enhancement capability supported by the network to a mobile station (MS);
requesting, by the MS, an enhanced mobile IP service according to an indication of the mobile IP enhancement capability supported by the network and mobile IP enhancement specifications when the MS supports the mobile IP enhancement capability; and
ignoring the indication and requesting the mobile IP service according to the mobile IP enhancement specifications which do not support mobile IP enhancement when the MS does not support the mobile IP enhancement capability.

2. The method according to claim 1, wherein the message indicating the mobile IP enhancement capability supported by the network is sent by a packet data access gateway in the network.

3. The method according to claim 2, when the packet data access gateway is a packet data serving node (PDSN) in a Code Division Multiple Access (CDMA) network, the method comprising:
sending, by the PDSN, a version capability indication message indicating a version capability to the MS based on a Point-to-Point Protocol (PPP) Vendor Extension;
returning, by the MS, a response to the PDSN based on the PPP Vendor Extension to indicate that the indication message is received; and
checking, by the MS, the version capability indication message and when the MS supports the mobile IP enhancement capability, checking whether the network supports mobile IP enhancement, and requesting the enhanced mobile IP service according to mobile IP enhancement specifications when the network supports mobile IP enhancement, or requesting the mobile IP service according to the specifications which do not support mobile IP enhancement when the network does not support mobile IP enhancement wherein when the MS does not support the mobile IP enhancement capability, ignoring the mobile IP enhancement capability indication, and requesting the mobile IP service according to the specifications which do not support mobile IP enhancement.

4. The method according to claim 3, wherein the version capability indication message contains the indication of the mobile IP enhancement capability and the MS checks the version capability indication by checking or ignoring the indication of the mobile IP enhancement capability.

5. The method according to claim 4, wherein the specific steps of the MS checking or ignoring the indication of the mobile IP enhancement capability comprise:
determining, by the MS, that the network supports mobile IP enhancement when the MS supports the mobile IP enhancement capability when the bit indicating the mobile IP enhancement capability is 1;
determining, by the MS, that the network does not support mobile IP enhancement when the bit indicating the mobile IP enhancement capability is 0; and
ignoring the mobile IP enhancement capability indication if the MS does not support the mobile IP enhancement capability.

6. The method according to claim 3, wherein the version capability indication message contains a Version field wherein the MS checks the version capability indication message by checking the Version field.

7. The method according to claim 6, wherein the specific steps of the MS checking the Version field comprise:
determining, by the MS, that the network supports mobile IP enhancement, when the MS supports the mobile IP enhancement capability when the Version field is 1;
determining, by the MS, that the network does not support mobile IP enhancement when the Version field is 0; and
checking whether the Version field is not smaller than 0 when the MS does not support the mobile IP enhancement capability.

8. The method according to claim 2, when the packet data access gateway is a PDSN in a CDMA network, the method comprising:
sending, by the PDSN, a message indicating the mobile IP enhancement capability to the MS based on a Point-to-Point Protocol (PPP) Vendor Extension; and
receiving, by the MS, the message indicating the mobile IP enhancement capability, and when the MS supports the IP enhancement capability, returning a response to the PDSN based on the PPP Vendor Extension to indicate that the indication message is received or when the MS does not support the mobile IP enhancement capability, which means it is unable to identify the indication message, returning a rejection message.

9. The method according to claim 8, after the MS returning a response to the PDSN, the method further comprising:
requesting, by the MS, the mobile IP enhancement service according to the mobile IP enhancement specifications.

10. The method according to claim 8 or claim 9, wherein when the MS does not support the mobile IP enhancement capability, the MS requests the mobile IP service according to the specifications which do not support mobile IP enhancement.

11. The method according to claim 2, wherein, when the packet data access gateway is a controlling access point (CAP) in a CDMA evolving network, the method comprises:
sending, by the CAP, a message indicating the mobile IP enhancement capability to the MS through an air interface; and
receiving, by the MS, the message indicating the mobile IP enhancement capability, and when the MS supports the IP enhancement capability, returning a response to the CAP through the air interface to indicate that the indication message is received or when the MS does not support the mobile IP enhancement capability, unable to identify the indication message, and thus returning a rejection message.

12. The method according to claim 11, wherein when the MS supports the IP enhancement capability, the MS requests the enhanced mobile IP service according to the mobile IP enhancement specifications.

13. The method according to claim 11, wherein when the MS does not support the mobile IP enhancement capability, the MS requests the mobile IP service according to the specifications which do not support mobile IP enhancement.
